(19) United States
(12) Patent Application Publication
(10) Pub. No.: US 2020/0385141 A1
(43) Pub. Date: Dec. 10, 2020

(54) DATA DRIVEN MACHINE LEARNING FOR MODELING AIRCRAFT SENSORS

(71) Applicant: The Boeing Company, Chicago, IL (US)

(72) Inventors: Andrew Louis Bereson, Seattle, WA (US); Debra Alice Rigdon, Kent, WA (US); Michael Thomas Swayne, Redmond, WA (US); Hieu Trung Nguyen, Tenton, WA (US)

(21) Appl. No.: 16/433,822

(22) Filed: Jun. 6, 2019

(51) Int. Cl. B64D 45/00; G06N 20/00; G06N 5/04; B64F 5/60

(52) U.S. Cl. CPC B64D 45/00; G06N 20/00; B64D 2045/0085; B64F 5/60; G06N 5/04

(57) ABSTRACT

A system may include a set of components that make up an engineered system configured to generate real-time data representing a set of real-time operational behaviors associated respectively with the set of components. The system may include a predictive model configured to predict a normal operational behavior associated with a component of the set of components relative to other normal operational behaviors associated respectively with other components of the set of components. The system may include a processor configured to receive the set of real-time operational behaviors, the set of real-time operational behaviors including a real-time operational behavior associated with the component, and to categorize the real-time operational behavior associated with the component as normal or anomalous based on the predictive model. The system may include an output device configured to output an indication of fault in response to the processor categorizing the real-time operation behavior as anomalous.

### FIELD OF THE DISCLOSURE

This disclosure is generally related to state sensing and/or fault sensing, and in particular to using data driven machine learning for modeling aircraft sensors.

### BACKGROUND

Engineered systems, such as factories and machinery, and in particular aircraft and other vehicles, typically include many components and subsystems. These components may be serviced or replaced at regular intervals to ensure proper functioning of the system. On occasion, components and/or subsystems may degrade unexpectedly outside of their service schedule. These degraded components may be identified through logs, noticeable effects, troubleshooting, scheduled inspections, and/or other types of fault detection methods. These events may lead to unscheduled maintenance and significant costs.

Current solutions are typically manual in nature and include support from someone who is an expert on a particular subsystem under scrutiny. This approach is time-consuming, expensive, and may not anticipate problems sufficiently to prevent unscheduled downtime. Current methods of detecting degraded components and subsystems also tend to generate a large number of false positives as well as missed detections.

Machine learning techniques have been applied to particular subsystems to attempt to identify issues. However, current machine learning solutions are subsystem focused and do not include data taken from other components or subsystems of the engineered system. As such, these approached may miss valuable latent information encoded in sensors throughout the system that capture environment and other external impacts. Thus, current machine learning techniques may not sufficiently detect degraded components and/or subsystems in the context of the entire engineered system. Other disadvantages may exist.

### SUMMARY

Disclosed herein are systems and methods for sensing degraded components or subsystems in the context of other components and/or subsystems of an engineered system. The disclosed systems and methods may accurately detect degraded components and reduce time and costs associated with unscheduled maintenance. For example, degradation of components may be a forerunner of failure, such that detection of degraded components may enable prediction of fault or failure. In an embodiment, a method includes receiving training data representing a set of operational behaviors associated respectively with a set of components that make up an engineered system. The method further includes generating a predictive model, based on the training data, configured to predict a normal operational behavior associated with a component of the set of components relative to other normal operational behaviors associated respectively with other components of the set of components. The method also includes receiving real-time data representing a set of real-time operational behaviors associated respectively with the set of components, the set of real-time operational behaviors including a real-time operational behavior associated with the component. The method includes categorizing the real-time operational behavior associated with the component as normal or anomalous based on the predictive model. The method further includes, in response to categorizing the real-time operational behavior as anomalous, generating an indication of fault diagnosis.

In some embodiments, the set of components includes vehicle components, and the engineered system is a vehicle. In some embodiments, the set of components includes aircraft components, and the engineered system is an aircraft. In some embodiments, the training data is received from multiple aircraft of a fleet of aircraft. In some embodiments, categorizing the real-time operational behavior associated with the component is performed at a processor within an avionics bay of the aircraft while the aircraft is in flight. In some embodiments, generating the predictive model includes training the predictive model through a supervised machine learning process using the training data. In some embodiments, the set of real-time operational behaviors includes sets of user inputs, sets of machine states, sets of measurements, or combinations thereof.

In some embodiments, the method includes generating a second predictive model, based on the training data, configured to predict a second normal operational behavior associated with a second component of the set of components relative to the other operational behaviors associated respectively with the other components of the set of components, where the set of real-time operational behaviors includes a second real-time operational behavior of the second component. In some embodiments, the method includes categorizing the second real-time operational behavior associated with the second component as normal or anomalous, and, in response to categorizing the second real-time operational behavior as anomalous, generating the indication of fault diagnosis.

In some embodiments, the indication of fault diagnosis identifies the component. In some embodiments, the method includes sending the indication of fault diagnosis to an output device.

In an embodiment, a system includes a set of components that make up an engineered system configured to generate real-time data representing a set of real-time operational behaviors associated respectively with the set of components. The system further includes a computer implemented predictive model configured to predict a normal operational behavior associated with a component of the set of components relative to other normal operational behaviors associated respectively with other components of the set of components. The system also includes a processor configured to receive the set of real-time operational behaviors, the set of real-time operational behaviors including a real-time operational behavior associated with the component, and to categorize the real-time operational behavior associated with the component as normal or anomalous based on the predictive model. The system includes an output device configured to output an indication of fault diagnosis in response to the processor categorizing the real-time operation behavior as anomalous.

In some embodiments, the system includes a second processor configured to receive training data representing a set of operational behaviors associated respectively with the set of components and to generate the predictive model based on the training data. In some embodiments, the set of components includes vehicle components, and the engineered system is a vehicle. In some embodiments, the set of components includes aircraft components, and the engineered system is an aircraft. In some embodiments, the processor is positioned within an avionics bay of an aircraft. In some embodiments, the set of components includes a set of user input devices, a set of machines, a set of measurement sensors, or combinations thereof.

In an embodiment, a method includes receiving real-time data representing a set of real-time operational behaviors associated respectively with a set of components that make up an engineered system, the set of real-time operational behaviors including a real-time operational behavior associated with a component of the set of components. The method further includes categorizing the real-time operational behavior associated with the component as normal or anomalous based on a predictive model configured to predict a normal operational behavior associated with the component relative to other normal operational behaviors associated respectively with other components of the set of components. The method also includes, in response to categorizing the real-time operational behavior as anomalous, generating an indication of fault diagnosis.

In some embodiments, the method includes receiving training data representing a set of operational behaviors associated respectively with the set of components and generating the predictive model, based on the training data. In some embodiments, generating the predictive model includes training the predictive model through a supervised machine learning process using the training data. In some embodiments, the set of real-time operational behaviors includes a set of user inputs, a set of machine states, a set of measurements, or combinations thereof.

### BRIEF DESCRIPTION OF THE DRAWINGS

FIG. 1 is a block diagram depicting an embodiment of a system for training a predictive model for sensing degraded components in an engineered system.

FIG. 2 is a block diagram depicting an embodiment of a system for using a predictive model to predict a normal operational behavior associated with a component of an engineered system.

FIG. 3 is a block diagram depicting an embodiment of a system for detecting a degraded component of an engineered system.

FIG. 4 is a flow diagram depicting an embodiment of a method for training a predictive model.

FIG. 5 is a flow diagram depicting an embodiment of a method for detecting a degraded component of an engineered system.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

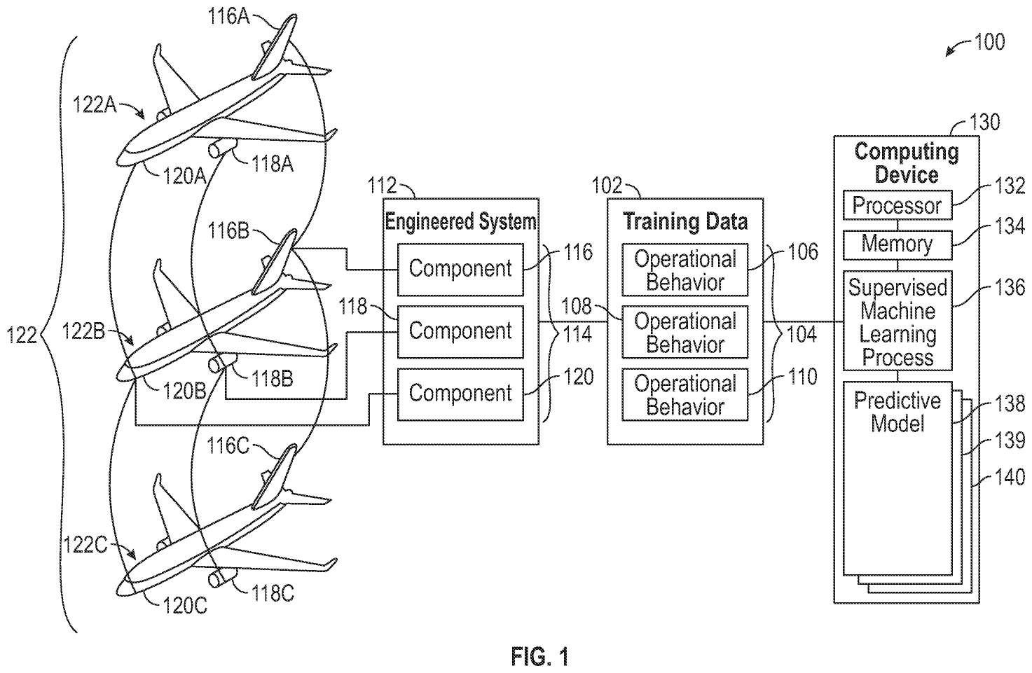

Referring to FIG. 1, an embodiment of a system 100 for training a predictive model 138 for sensing degraded components in an engineered system 112 is depicted. The engineered system 112 may include a set of components 114 having a first component 116, a second component 118, and a third component 120. While three components are depicted for illustrative purposes, it should be understood that in practice, the set of components 114 may include more or fewer than three. In most practical application, the set of components 114 may include numerous components.

The engineered system 112 may correspond to a vehicle, such as an aircraft. For example, FIG. 1 depicts a fleet of aircraft 122 including a first aircraft 122A, a second aircraft 122B, and a third aircraft 122C. Each of the aircraft 122A-C may be of the same type and include the same components as each other. As such, each of the aircraft 122A-C may correspond to the engineered system 112.

To illustrate, the first aircraft 122A may include a first component 116A that corresponds to the first component 116, a second component 118A that correspond to the second component 118, and a third component 120A that corresponds to the third component 120. Likewise, the second aircraft 122B may include a first component 116B that corresponds to both the first component 116A and the first component 116, a second component 118B that correspond to both the second component 118A and the second component 118, and a third component 120B that corresponds to both the third component 120A and the third component 120. Finally, the third aircraft 122C may include: a first component 116C that corresponds to the first component 116A, the first component 116B, and the first component 116; a second component 118C that correspond to the second component 118A, the second component 118B, and the second component 118; and a third component 120C that corresponds to the third component 120A, the third component 120B, and the third component 120.

Each of the components 116, 118, 120 may continually produce data during a flight. For example, the set of components 114 may include a set of user input devices (e.g., flight controls, user prompts, audio and video recordings, etc.), a set of machines (e.g., control surfaces, engine systems, motors, etc.), a set of measurement sensors (e.g., pressure sensors, temperature sensors, etc.), or combinations thereof. When produced in large quantities, the data produced by the set of components 114 may be used as training data 102.

The training data 102 may represent a set of operational behaviors 104 associated respectively with the set of components 114 that make up the engineered system 112. For example, the training data 102 may represent a first operational behavior 106 associated with the first component 116, a second operational behavior 108 associated with the second component 118, and a third operational behavior 110 associated with the third component 120. Because the training data 102 is continuously collected during normal operation of the engineered system 112, the set of operational behaviors 104 may include, with few exceptions, nominal behaviors suitable for training the predictive model 138. It should be noted that some off-nominal data in the training data stream is expected. However, given the large amounts of data received, the off-nominal data may not rise to a level of significance. Thus, the disclosed system 100 may be a robust solution capable of accepting training data with such “noise.” Further, because the training data 102 may be collected over the fleet of aircraft 122, the set of operational behaviors 104 may describe nominal behaviors in the context of the fleet of aircraft 122 as opposed to any individual aircraft of the fleet of aircraft 122.

The system 100 may include a computing device 130 configured to train the predictive model 138. The computing device 130 may include a processor 132 and a memory 134. The processor 132 may include a central processing unit (CPU), a graphical processing unit (GPU), a digital signal processor (DSP), a peripheral interface controller (PIC), or another type of microprocessor. It may be implemented as an integrated circuit, a field programmable gate array (FPGA), an application specific integrated circuit (ASIC), a combination of logic gate circuitry, other types of digital or analog electrical design components, or the like, or combinations thereof. In some embodiments, the processor 132 may be distributed across multiple processing elements, relying on distributive processing operations.

Further, the computing device 130 may include memory 134 such as random-access memory (RAM), read-only memory (ROM), magnetic disk memory, optical disk memory, flash memory, another type of memory capable of storing data and processor instructions, or the like, or combinations thereof. In some embodiments, the memory, or portions thereof, may be located externally or remotely from the rest of the computing device 130. The memory 134 may store instructions that, when executed by the processor 132, cause the processor 132 to perform operations. The operations may correspond to any operations described herein. In particular, the operations may correspond to training the predictive model 138.

The processor 132 and the memory 134 may be used together to implement a supervised machine learning process 136 to generate the predictive model 138. The predictive model 138 may include any artificial intelligence model usable to categorize operational behaviors as normal or anomalous. For example, the predictive model 138 may include decision trees, association rules, other types of machine learning classification processes, or combinations thereof. It may be implemented as support vector machine networks, Bayesian networks, neural networks, other types of machine learning classification network systems, or combinations thereof.

During operation, the training data 102 may be received from multiple system implementations. For illustration purposes, FIG. 1 depicts the training data 102 as being received from the fleet of aircraft 122, or from any single aircraft 122A, 122B, 122C within the fleet of aircraft 122, depending on whether the engineered system 112 is to be analyzed at a fleet level or at an individual aircraft level. Although FIG. 1 depicts aircraft, it should be understood that the engineered system may correspond to any type of mechanical or electrical system, and not just aircraft. The predictive model 138 may then be trained through the supervised machine learning process 136 using the training data 102. Because the set of operational behaviors 104 may include, for the most part, nominal behaviors of the set of components 114, the predictive model 138 may be configured to distinguish between normal operational behaviors and anomalous operational behaviors for the first component 116. Beneficially, the predictions may be based not only on the first operational behavior 106 associated with the first component 116, but also on the other operational behaviors 108, 110 that are not associated with component 116, but which may be relevant as the second component 118 and third component 120 interact with the first component 116 within the engineered system 112. In a like manner, a second predictive model 139 may be generated to distinguish between normal and anomalous operational behaviors of the second component 118, and a third predictive model 140 may be generated to distinguish between normal and anomalous operational behaviors of the third component 120.

By training the predictive model 138 based on the training data 102 that represents other operational behaviors 108, 110 of other components 118, 120, in additional to the first operational behavior 106 of the first component 116, the predictive model 138 may be configured to take into account the engineered system 122 as a whole in determining whether the first component 116 is operating in a normal or anomalous way. Similar benefits exist for the second predictive model 139 and the third predictive model 140. Other advantages may exist.

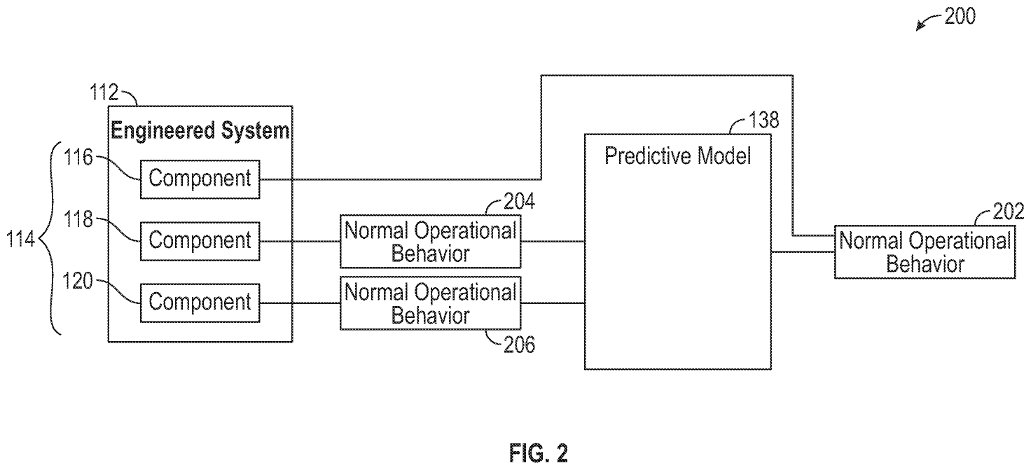

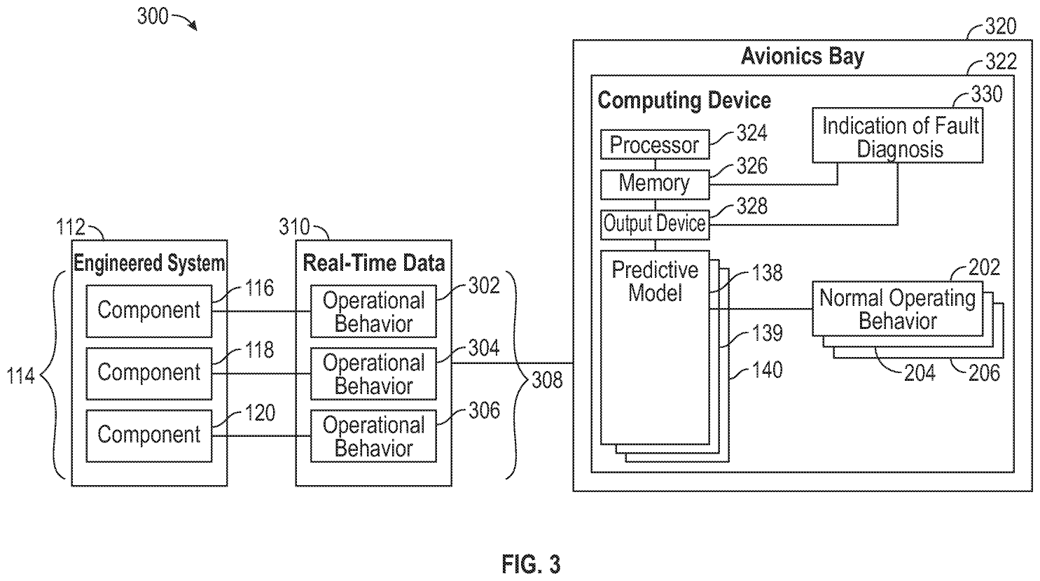

Referring to FIG. 2, an embodiment of a system 200 for using a predictive model 138 to predict a first normal operational behavior 202 associated with a component 116 of an engineered system 112 is depicted. Once the predictive model 138 is trained, as described with reference to FIG. 1, it may be used to predict the first normal operational behavior 202 of the first component 116. For example, a second normal operating behavior 204 of the second component 118 and a third normal operational behavior 206 of the third component 120 may be input into the predictive model 138. Based on the second normal operating behavior 204 and the third normal operational behavior 206, the predictive model 138 may determine or predict the first normal operational behavior 202 of the first component 116. As explained further with respect to FIG. 3, the predicted first normal operational behavior 202 may be compared to an actual behavior of the component 116 to determine whether the component 116 is behaving normally or anomalously. Although FIG. 2 is directed to predicting the first normal operational behavior 202 of the first component 116, the second predictive model 139 may be used in a similar fashion to predict the second normal operational behavior 204 of the second component 118 based on the first normal operational behavior 202 and the third normal operational behavior 206, and the third predictive model 140 may be used in a similar fashion to predict the third normal operational behavior 206 of the third component 120 based on the first normal operational behavior 202 and the second normal operational behavior 204.

Referring to FIG. 3, an embodiment of a system 300 for detecting a degraded component of an engineered system 112 is depicted. The system 300 may include the engineered system 112 with the set of components 114 and a computing device 322. In the case where the engineered system 112 is an aircraft, the computing device 322 may be positioned within an avionics bay 320 of the aircraft. Alternatively, the computing device 322 may be ground-based and may be used for post-flight processing.

The computing device 322 may include a processor 324, a memory 326, and an output device 328. The processor 324 may include a central processing unit (CPU), a graphical processing unit (GPU), a digital signal processor (DSP), a peripheral interface controller (PIC), or another type of microprocessor. It may be implemented as an integrated circuit, a field programmable gate array (FPGA), an application specific integrated circuit (ASIC), a combination of logic gate circuitry, other types of digital or analog electrical design components, or the like, or combinations thereof. In some embodiments, the processor 324 may be distributed across multiple processing elements, relying on distributive processing operations.

The memory 326 may include random-access memory (RAM), read-only memory (ROM), magnetic disk memory, optical disk memory, flash memory, another type of memory capable of storing data and processor instructions, or the like, or combinations thereof. In some embodiments, the memory 326, or portions thereof, may be located externally or remotely from the rest of the computing device 322. The memory 326 may store instructions that, when executed by the processor 324, cause the processor 324 to perform operations. The operations may correspond to any operations described herein. In particular, the operations may correspond to using the predictive model 138 for detecting a fault with one of the components 116, 118, 120.

The output device 328 may include any device capable of communicating with users or devices external to the computing device 322. For example, the output device 328 may include a user output device, such as an indicator light, a display screen, a speaker, etc. The output device 328 may also include a network output device, such as a serial communication device, a network card, etc.

The predictive models 138, 139, 140 may be stored at the computing device 322, either at the memory 326 or in another form. Based on outcomes of using the predictive models 138, 139, 140, an indication of fault diagnosis (e.g. fault detection) 330 may be generated as described herein. The output device 328 may be configured to communicate the indication of fault diagnosis 330 to a user or to another device.

During operation, the engineered system 112 may generate real-time data 310 including a set of real-time operational behaviors 308. As used herein, the term “real-time” means that the real-time data 310 corresponds to a currently occurring operation (such as a flight that is currently occurring) or to a most recent operation (such as the most recent flight taken by an aircraft). In particular, the concept of “real-time” is intended to take into account delays with accessing data. The set of real-time operational behaviors 308 may include a first real-time operational behavior associated with the first component 116, a second real-time operational behavior associated with the second component 118, and a third real-time operational behavior associated with the third component 120.

The computing device 322 may receive real-time data 310. Based on the real-time data 310, the processor 324 may categorize the first real-time operational behavior 302 associated with the component 116 as normal or anomalous based on the predictive model 138. For example, the predictive model 138 may calculate a normal operating behavior 202 for the first component 116. The first normal operating behavior 202 may be compared to the first real-time operational behavior 302 to determine whether the first real-time operational behavior 302 is anomalous. In response to categorizing the first real-time operational behavior 302 as anomalous, the processor 324 may generate the indication of fault diagnosis 330. In some embodiments, the categorization of the first real-time operational behavior 302 may occur during a flight.

Similar calculations may be made to determine whether the second real-time operational behavior 304 and/or the third real-time operational behavior 306 are anomalous. For example, the second predictive model 139 may calculate a second normal operational behavior 204 associated with the second component 118 and the third predictive model 140 may calculate a third normal operating behavior 206 associated with the third component 120. Thus, for each of the components 116, 118, 120, the corresponding normal operational behaviors 202, 204, 206 may be calculated based on the other operational behaviors of the real-time set of operational behaviors 308. If any operational behavior of the set of real-time operational behaviors 308 is anomalous, then the indication of fault diagnosis 330 may be generated, indicating which of the components 116, 118, 120 is operating anomalously.

By using the predictive models 138-140 that classify the real-time data 310 based on the real-time operational behaviors 302, 304, 306 of each of the components 116, 118, 120, the system 300 may detect degraded components and/or subsystems in the context of the entire engineered system, as opposed to a behavior of a single component. As such, the system 300 may detect anomalous behavior that other detection systems may miss. Other benefits may exist.

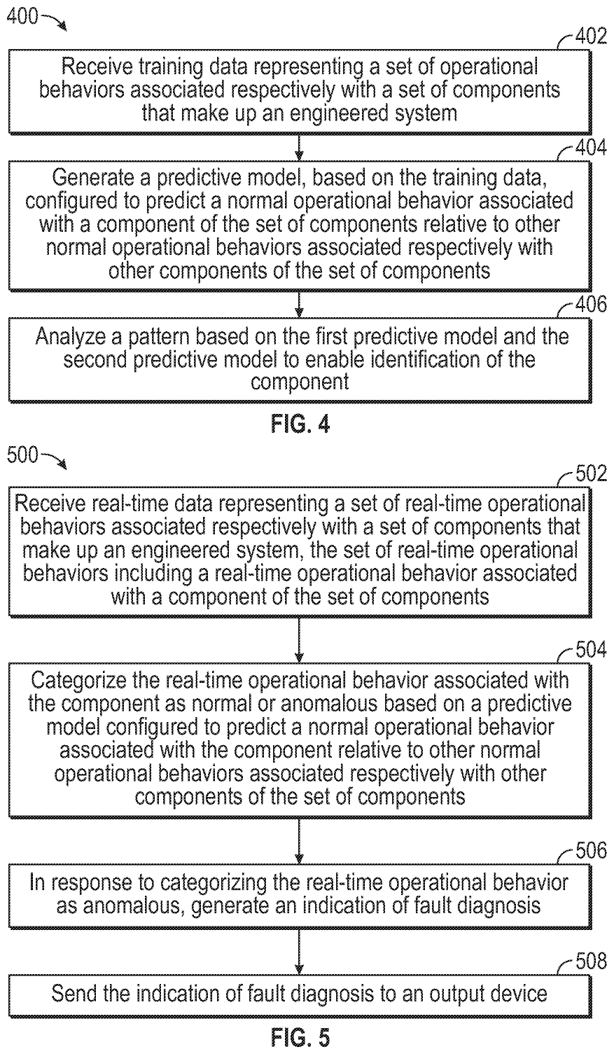

Referring to FIG. 4, an embodiment of a method 400 for training a predictive model is depicted. The method 400 may include receiving training data representing a set of operational behaviors associated respectively with a set of components that make up an engineered system, at 402. For example, the training data 102 may be received at the computing device 130.

The method 400 may further include generating a predictive model, based on the training data, configured to predict a normal operational behavior associated with a component of the set of components relative to other normal operational behaviors associated respectively with other components of the set of components, at 404. For example, the predictive models 138, 139, 140 may be generated to predict normal operational behaviors associated with the components 116, 118, 120 relative to the engineered system 112 as a whole in order to diagnose degradation within the engineered system 112, which may be related to components other than those modeled by the predictive models 138, 139, 140. The method 400 may also include analyzing a pattern based on the first predictive model and the second predictive model to enable identification of the component, at 406. By analyzing patterns associated with which of the predictive models 138, 139, 140 indicate anomaly and which indicate normalcy, it may be determined which subsystem, and even which component within the subsystem, may be a root cause of the anomalous behavior. In other words, a degraded part that requires replacing may be discovered.

Thus, by generating a predictive model configured to predict a normal operational behavior associated with a component relative to other normal operational behaviors associated respectively with other components of an engineered system, the method 400 may take into account an engineered system as a whole in determining whether operation of a component is normal or anomalous. Other advantages may exist.

Referring to FIG. 5, an embodiment of a method 500 for detecting a degraded component of an engineered system is depicted. The method 500 may include receiving real-time data representing a set of real-time operational behaviors associated respectively with a set of components that make up an engineered system, the set of real-time operational behaviors including a real-time operational behavior associated with a component of the set of components, at 502. For example, the real-time data 310 may be received by the computing device 322.

The method 500 may further include categorizing the real-time operational behavior associated with the component as normal or anomalous based on a predictive model configured to predict a normal operational behavior associated with the component relative to other normal operational behaviors associated respectively with other components of the set of components, at 504. For example, the first real-time operational behavior 302 may be categorized by the predictive model 138.

The method 500 may also include, in response to categorizing the real-time operational behavior as anomalous, generating an indication of fault diagnosis, at 506. For example, the processor 324 may generate the indication of fault diagnosis 330.

The method 500 may include sending the indication of fault diagnosis to an output device, at 508. For example, the indication of fault diagnosis 330 may be sent to the output device 328 for output.

By categorizing the real-time operational behavior associated with the component as normal or anomalous based on a predictive model configured to predict a normal operational behavior associated with the component relative to other normal operational behaviors associated respectively with other components of the set of components, the method 400 may detect degraded components and/or subsystems in the context of the entire engineered system, as opposed to a behavior of a single component. Other benefits may exist.

Although various embodiments have been shown and described, the present disclosure is not so limited and will be understood to include all such modifications and variations as would be apparent to one skilled in the art.

What is claimed is:

1. A method comprising:
receiving training data representing a set of operational behaviors associated respectively with a set of components that make up an engineered system;
generating a predictive model, based on the training data, configured to predict a normal operational behavior associated with a component of the set of components relative to other normal operational behaviors associated respectively with other components of the set of components;
receiving real-time data representing a set of real-time operational behaviors associated respectively with the set of components, the set of real-time operational behaviors including a real-time operational behavior associated with the component;
categorizing the real-time operational behavior associated with the component as normal or anomalous based on the predictive model; and
in response to categorizing the real-time operational behavior as anomalous, generating an indication of fault diagnosis.

2. The method of claim 1, wherein the set of components includes vehicle components, and wherein the engineered system is a vehicle.

3. The method of claim 1, wherein the set of components includes aircraft components, and wherein the engineered system is an aircraft.

4. The method of claim 3, wherein the training data is received from multiple aircraft of a fleet of aircraft.

5. The method of claim 3, wherein categorizing the real-time operational behavior associated with the component is performed at a processor within an avionics bay of the aircraft while the aircraft is in flight.

6. The method of claim 1, wherein generating the predictive model comprises training the predictive model through a supervised machine learning process using the training data.

7. The method of claim 1, wherein the set of operational behaviors of the training data include both nominal and off-nominal operational behaviors.

8. The method of claim 1, wherein the set of real-time operational behaviors includes sets of user inputs, sets of machine states, sets of measurements, or combinations thereof.

9. The method of claim 1, further comprising:
generating a second predictive model, based on the training data, configured to predict a second normal operational behavior associated with a second component of the set of components relative to the other operational behaviors associated respectively with the other components of the set of components, wherein the set of real-time operational behaviors includes a second real-time operational behavior of the second component;
categorizing the second real-time operational behavior associated with the second component as normal or anomalous; and
in response to categorizing the second real-time operational behavior as anomalous, generating the indication of fault diagnosis.

10. The method of claim 1, further comprising:
analyzing a pattern based on the first predictive model and the second predictive model to enable identification of the component, wherein the indication of fault diagnosis identifies the component.

11. The method of claim 1, further comprising:
sending the indication of fault diagnosis to an output device.

12. A system comprising:
a set of components that make up an engineered system configured to generate real-time data representing a set of real-time operational behaviors associated respectively with the set of components;
a computer implemented predictive model configured to predict a normal operational behavior associated with a component of the set of components relative to other normal operational behaviors associated respectively with other components of the set of components;
a processor configured to receive the set of real-time operational behaviors, the set of real-time operational behaviors including a real-time operational behavior associated with the component, and to categorize the real-time operational behavior associated with the component as normal or anomalous based on the predictive model; and
an output device configured to output an indication of fault diagnosis in response to the processor categorizing the real-time operation behavior as anomalous.

13. The system of claim 12, further comprising:
a second processor configured to receive training data representing a set of operational behaviors associated respectively with the set of components and to generate the predictive model based on the training data.

14. The system of claim 12, wherein the set of components includes vehicle components, and wherein the engineered system is a vehicle.

15. The system of claim 12, wherein the set of components includes aircraft components, and wherein the engineered system is an aircraft.

16. The system of claim 12, wherein the set of components includes a set of user input devices, a set of machines, a set of measurement sensors, or combinations thereof.

17. A method comprising:
receiving real-time data representing a set of real-time operational behaviors associated respectively with a set of components that make up an engineered system, the set of real-time operational behaviors including a real-time operational behavior associated with a component of the set of components;
categorizing the real-time operational behavior associated with the component as normal or anomalous based on a predictive model configured to predict a normal operational behavior associated with the component relative to other normal operational behaviors associated respectively with other components of the set of components; and
in response to categorizing the real-time operational behavior as anomalous, generating an indication of fault diagnosis.

18. The method of claim 17, further comprising:
receiving training data representing a set of operational behaviors associated respectively with the set of components; and
generating the predictive model, based on the training data.

19. The method of claim 18, wherein generating the predictive model comprises training the predictive model through a supervised machine learning process using the training data.

20. The method of claim 17, wherein the set of real-time operational behaviors includes a set of user inputs, a set of machine states, a set of measurements, or combinations thereof.
